(19) United States
(12) Patent Application Publication
(10) Pub. No.: US 2006/0029773 A1
(43) Pub. Date: Feb. 9, 2006

(54) Surface protection system

(76) Inventors: Wade Richard Waterman, Canal Winchester, OH (US); Bryan Larry Watkins, Hanover, IN (US)

Correspondence Address: Wade Richard Waterman, 7831 Brooks Bend Ct., Canal Winchester, OH, 43110, US

(21) Appl. No.: 11/197,848

(22) Filed: Aug. 6, 2005

Related U.S. Application Data
(60) Provisional application No. 60/599,357, filed on Aug. 6, 2004.

(51) Int. Cl. B32B 3/10

(52) U.S. Cl. 428/138; 428/167

(57) ABSTRACT

An surface protection system of manufacture for protecting the surfaces, including restroom floors, from accidental liquid spills, including urine and water, with a top unit containing grid work of any geometric design containing a slip resistance top design that directs liquid down and into the absorbing core; an absorbing core attached to the top unit by any method, consisting of non woven material containing super absorbent polymer or super absorbent fiber, or similar material that has a high rate of absorbency and capacity to retain the liquid in the material; a moister barrier attached to the absorbing core and the top unit by any permanent means, including glue, heat welding, or other methods, and optionally, a backing unit containing slip resistant characteristics. All components being combined into one surface protection system that also provides for the user to stand on a portion of it, allowing a closer position to a urinal, toilet, beverage machine, drinking fountain, or other intended use of the surface protection system. An article of manufacture for protecting the counter surfaces from accidental liquid spills, including coffee, carbonated beverages, and water, with a top unit containing grip work grid work of any geometric design containing a slip resistance top design that directs liquid down and into the absorbing core; an absorbing core attached to the top unit by any method, consisting of non woven material containing super absorbent polymer or super absorbent fiber, or similar material that has a high rate of absorbency and capacity to retain the liquid in the material; a moister barrier attached to the absorbing core and the top unit by any permanent means, including glue, heat welding, or other methods, and optionally, a backing unit containing slip resistant characteristics. All components being combined into one surface protection system that also provides for the user to stand on a portion of it, allowing a closer position to a urinal, toilet, beverage machine, drinking fountain, or other intended use of the surface protection system.

### CROSS REFERENCE TO RELATED APPLICATIONS

Provisional Application 60/559,357, filed Aug. 06, 2004, Confirmation No. 3276.

Surface Protection mat, an article of manufacture for protecting surfaces, such as counters, table tops, floors, including restroom floors, from accidental liquid spills.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of surface protection and more specifically to an article of manufacture for protecting the floor surfaces of restrooms from accidental liquid spills, including urine and water, and also including the protection of counter, table top, and floor surfaces exposed to liquid spills from coffee, carbonated beverages, and water. The use of microwaves, coffee and carbonated beverage vending machines generate accidental spills of liquids, some hot and other leaving a sticky residue. Additionally, the use of restrooms generates accidental urine splashes and spills, and water overflow due to stoppage of the drain.

Normal maintenance is unable to clean after each person's use. Accordingly, coffee, carbonated beverages, hot liquids, water, and in the context of restrooms, urine, will contaminate the counter, table top and floor surfaces. Over time, such spills damage the floor surface, including producing stains and in some cases, offensive odors.

Many ideas have been generated over the past 50 years, including mats that attempt to protect the surfaces, including floors. Some have proved effective, however, the combination of the most effective materials, such as the use of super absorbent materials provides vastly improved utility and superior protection in coverage by allowing for absorbing designed mats that hold and retain the liquid. Such subsequent ideas produced inventions, such as U.S. Pat. No. 6,295,658 that made ineffective use of the new absorbent materials not available to Cordani in U.S. Pat. No. 5,506,040. U.S. Pat. No. 6,446,275 eliminated the underlying base unit and allowed the liquid to enter the absorbing core directly, over the entire length of the mat. Yet, this patent failed to correctly describe the result of the base being eliminated, filing it as a contingent claim (#7), with the result that the subsequent manufacture and sale of the single, three piece unit in July 2001 put his idea into the public domain. Although U.S. Pat. No. 6,875,494 has been issued covering this technology, that idea had passed into the public domain on August 2002, four months prior to that patent application being submitted, and which failed to correct indicate the inventors of that idea. Stickler, in U.S. Pat. No. 6,787,210 (B2) continued the same problem of the design of the surface of the top portion of the invention to avoid the user from standing on the device. This invention incorporates the new idea of a slip resistant surface either via slip resistant geometric patterns on the top surface, or by use of material that is naturally slip resistant, such as water resistant paperboard.

The shortcomings in prior technology existed in that the absorbing materials either poorly retain or failed to retain liquid. Until the invention of super absorbent materials, such as polymers and fibers, the absorbing materials suggested or used leaked and allowed odors to escape. With the invention of super absorbent materials, the odor problem was addressed. However, the inventions were difficult to manufacture, especially when petroleum based products were used, such a polypropylene, or other injected molded plastic, flexible or ridged. Additionally, such surfaces were slippery requiring the user to avoid stepping on the invention. With such limitations incorporated into the design of prior inventions, coverage area was restricted. In the context of restroom floors, such inventions left substantial floor areas unprotected when used under a urinal or around a commode. Specifically, such inventions could not be safely used with floor mounted urinals, as the user would be required to stand directly on the mat during use.

Through the use of a slip resistant top surface via ribbing or similar slip resistant patterns used in the top unit's geometric designs when and where necessary, the user can safely step on a portion or all of the mat allowing more comfortable use of the urinal and commode. This invention improvement allows for the invention to be made of petroleum based products, such as polypropylene or other injected molded plastics. However, another invention improvement is the use of paperboard in lieu of injected molded plastics for the top unit and the bottom unit, as such material has a natural slip resistant surface. In the context of restrooms, this allows the user to stand closer to the urinal or commode eliminating the awkward stance required with inventions that do not allow the user to stand on the mat. This improved invention allows for a greater coverage area as it allows larger designs.

Additionally, this invention can be used on floors in front of beverage vending machines, as the users can step on the mat while using the vending machine. The lower manufacturing cost of using paperboard as opposed to petroleum based products for surface protection mats increases its acceptability as a disposable mat and one that is environmental friendly.

### BRIEF SUMMARY OF THE INVENTION

The primary object of the invention is to provide greater utility in use by providing a light weight, disposable mat for protecting such surfaces as counter tops, table tops, floors around vending machines, drinking fountains, and in the context of restrooms, under urinals and around commodes (or under wall mounted commodes), designed to allow the user to stand on a portion or the entire mat.

Another object of the invention is to provide for a larger mat surface increasing the protection area for vending machines, and in the context of the restroom floor, a larger mat under urinals and around or under commodes.

Another object of the invention is to reduce maintenance around coffee machines, microwave ovens, and beverage vending machines.

Another object of the invention is the slip resistant top that allows the user to stand closer to the vending machine or in restroom use, the urinal or commode, reducing urine splash.

A further object of the invention is the slip resistant top that provides a higher grid design than prior inventions, creating a greater distance between the absorbent core and the users shoes.

Still yet another object of the invention is that the slip resistant design accommodates different urinal designs, including floor mounted urinals that often create additional water splash problems during flushing. This invention utilizes the slip resistant design and a drain lip to control this additional water splash problem.

Another object of the invention is that the absorbing core can be increased in holding strength to provide longer service in high traffic restrooms. The increased thickness is accomplished by the thinner and lighter paperboard top and/or bottom unit.

Other objectives and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for protecting the floor surfaces of restrooms from accidental liquid spills, including urine and water, comprising:

A top unit with grid work of any geometric design, and containing a slip resistance surface, either by use of paperboard, or the use of ribbing or other effective methods to provide a slip resistant surface when manufactured via injected molded plastic, with sufficient height above the absorbing core to adequately separate the users shoes from the absorbing core, such top unit geometric design directing liquid down and into the absorbing core;

An absorbing core attached to the top unit by various means, including heat welding or glue, consisting of non woven material containing super absorbent polymer or super absorbent fiber, or similar material that has a high rate of absorbency and capacity to retain the liquid and odor in the material;

A moister barrier attached to the absorbing core and top unit by any means, including heat welding or glue, that also functions as a slip resistant backing;

All three pieces being combined into one mat; except when constructed of paperboard, then the addition of a bottom unit consisting of paperboard, attached to the moister barrier by any means, including heat welding or glue;

All four pieces being combined into one mat. Accordingly, the single unit construction may contain more than two composite parts assembled into one final invention.

A mat that allows the user to stand on it, allowing the user to be closer to the urinal or commode;

A mat that incorporates a slip resistant top grid pattern;

A mat that is a single, disposable, one piece unit after manufacture and assembly;

A mat that reduces accidental displacement by allowing the user to stand on the mat during use;

A mat that allows use of an absorbent core with greater holding capacity, and thus a thicker absorbing core, over prior inventions but retaining the same overall height by eliminating the ‘base unit’; and

A mat with a higher grid design providing a greater distance between the absorbent core and the user, but retaining the same overall height by eliminating the ‘base unit’.

A mat constructed from paperboard, totally disposable, environmentally friendly, and easy to dispose in janitorial poly bags often used in commercial or residential cleaning.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention. As the invention may be embodied in many forms without departing from the spirit of essential characteristics indicated above, it is expressly stated that the drawings are for purposes of illustration and description only, and are not intended as a definition of the limits of the invention.

FIG. 1 is an enlarged view of the improvement of the urinal mat that incorporates the idea of a slip resistant design, allowing the user to stand upon the mat, and which allows the user to stand closer to the urinal, and which also allows for a larger designed mat providing for a greater coverage area of the floor surface;

FIGS. 2 A to 2E are enlarged and exaggerated views of various slip resistant geometric designs that provide the slip resistant ribbing for any surface protection mat allowing the user to step or stand upon the mat;

FIG. 3 is a view of an additional embodiment of a different slip resistant geometric design that may incorporate the slip resistant ribbing for any surface protection mat;

FIG. 4 is a view of a rectangle shape urinal mat incorporating the invention of slip resistant design in a geometric shape consisting of a square grid design allowing liquid to be channeled into the absorbing core, and which provides for the user to stand on the mat, standing closer to the urinal and eliminating the awkward stance required when the mat is designed to avoid the user from standing directly on the mat, and which allows a greater coverage area of the surface under and around the wall mounted urinal;

FIGS. 5A and 5B are views of embodiments of the surface protection mat system for floor mounted urinals, each mat containing the slip resistant feature, and consisting to two (2) separate units. The first unit is manufactured to the specific design of the floor mounted urinal, and the second unit is the extension unit providing a greater coverage area, and is the same for any floor mounted design, as it attaches to the first unit by means of attaching strips. Each front unit is mated with the specific design of the floor mounted urinal, allowing the front lit of the front unit return splashed water back into the urinal. This embodiment may also be manufactured of paperboard, which may consist on a single constructed mat and sufficient front lip area allowing the user to cut the front portion to match any floor mounted design;

FIG. 6 is a view of the attaching strip for the two units designed for floor mounted urinals;

FIGS. 7A to 7C are views of the commode style surface protection mat with the coverage extension unit attached, when used under wall mounted commodes, along with a detail view of the extension unit both units incorporating the invention of slip resistant design in a geometric shape consisting of a square grid design allowing liquid to be channeled into the absorbing core, and which provides for the user to stand on or place one's feet on the mat during use, and the attaching system used to lock the extension unit into the mat when the square gird design is used.

FIG. 8 is a view of the slip resistant design invention incorporated into a larger floor mat for entrance ways, and when constructed following FAA specifications for flame resistant construction, for use in the restrooms of aircraft;

FIGS. 9A to 9C are views of the slip resistant design invention incorporated into an industrial mat for use under machinery or for use in entrance ways, that can be expanded to larger coverage areas through the use of locking attaching strip;

FIGS. 10A and 10B are views of two different size embodiments of the slip resistant design invention incorporated into a surface protection system for use against beverage dispensing machines and floor mounted water fountains, and also for use on counter top surfaces against coffee machines and microwave ovens, with the larger size (10B) for use under wall mounted water fountains;

FIG. 11 is another embodiment of the slip resistant design invention incorporated into a surface protection system for residential or office use, made for placement of overshoes, boots, and other inclement weather footwear;

FIG. 12 is another embodiment of the slip resistant design invention incorporated into a table top surface protection system as a coaster;

FIG. 13 contains the construction view of the surface protection mat when manufactured from polypropylene or similar plastic materials, indicating the cartridge top, the absorbing core, and the moisture barrier that also serves as a slip resistant backing, combined into a single unit;

FIG. 14 contains the construction view of the surface protection mat when manufactured from paperboard, indicating the cartridge top, the absorbing core, the moisture barrier, and the paperboard backing that also serves as an slip resistant backing, combined into a single unit.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

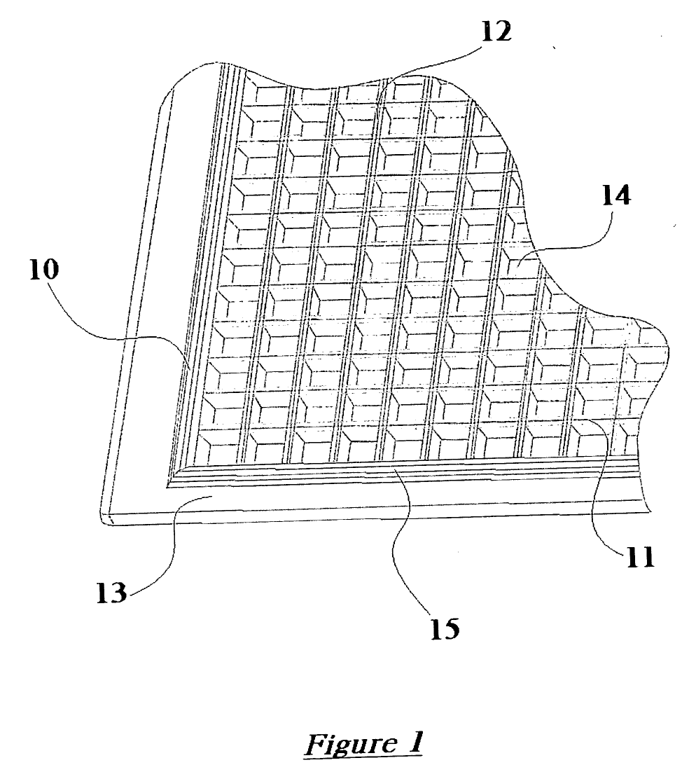

Turning first to FIG. 1, there is shown a portion of the top, such top unit's square geometric design can be seen containing a slip resistant ribbing [10, 11, 12, and 15] on each side of the pattern, both vertically and horizontally in this embodiment. This geometric design allows for the channeling of liquid downward into the absorbent core [14]. The side walls of the square geometric design is manufactured to height that lifts the grid above the absorbing core sufficiently to avoid the user's shoes from coming in contact with the urine or water. The lip of the mat is used for bonding of the layered absorbing core and moisture barrier on the reverse side [13].

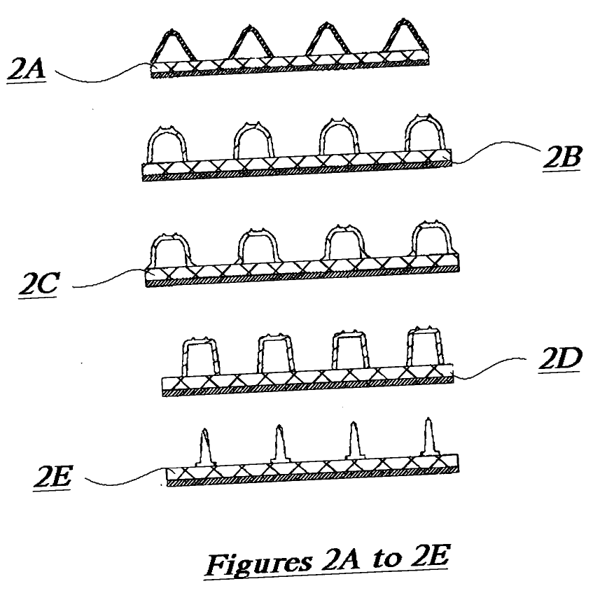

Turning now to FIGS. 2A to 2E, there is shown a pyramid shape with single slip resistant ridges [2A]; a rounded top with two slip resistant ridges [2B]; a flat top with two slip resistant ridges [2C]; a square top with two slip resistant ridges [2D]; and a dagger shaped single ridge with a single slip resistant ridge.

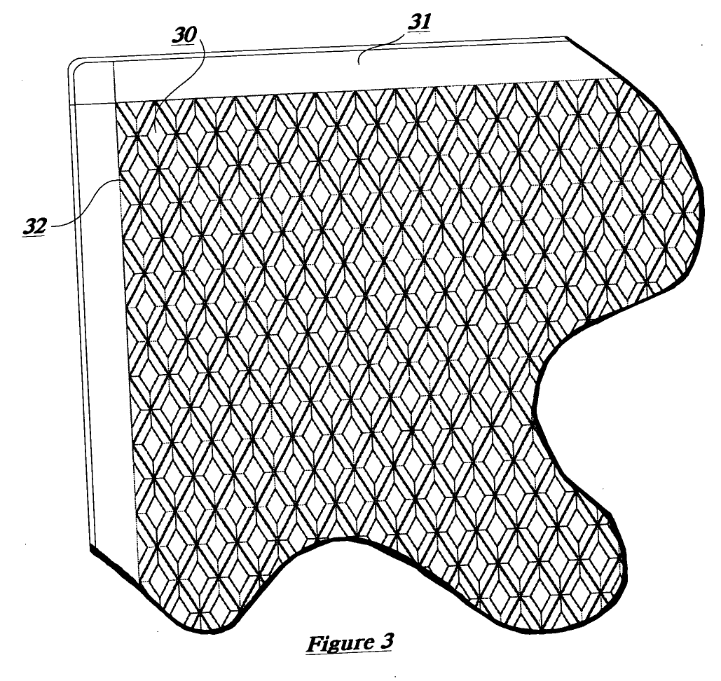

Turning now to FIG. 3, another embodiment of the slip resistant geometric designs possible is shown, with a dagger shaped single ridge with a single slip resistant ridge [32] incorporated into a diamond design [30].

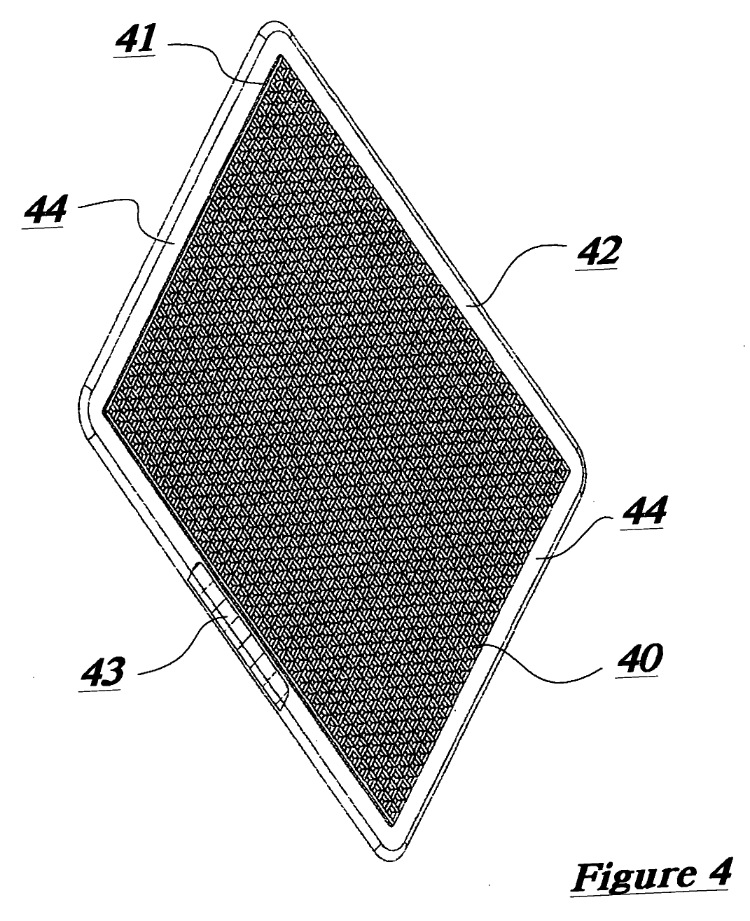

Turning now to FIG. 4, there is shown an additional embodiment of the new idea of a stand on mat, with a square geometric design to channel liquid into the absorbent core [40], and with a pyramid shaped geometric design containing single slip resistant ridging [41], and allowing either edge of the device to be placed against the wall under a wall mounted urinal [44]; and providing for customer information or other identification desired by a purchaser on the side [43]; and the same lip for attaching the absorbent core and moisture barrier [42].

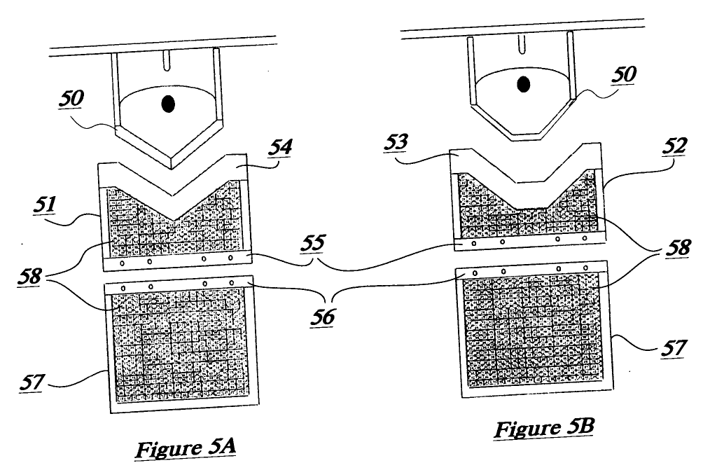

Turning now to FIGS. 5A and 5B, there is shown an additional embodiment of the new idea of a stand on floor mounted urinal mat system, consisting of two units when manufactured from plastic or other solid material, a front unit that mates to the specific style of the lip of the floor mounted urinal [50]; the front unit matting with the “V” shaped urinal [5A] and the off set shaped urinal [5B]; containing the drain lip [53 and 54], the lip for assembling the absorbent core and moisture barrier [51, 52, 56 and 57]; with attaching holes for the locking strip [55 and 56]; and utilizing a pyramid shaped geometric design containing a single dagger shaped slip resistant ridging [58].

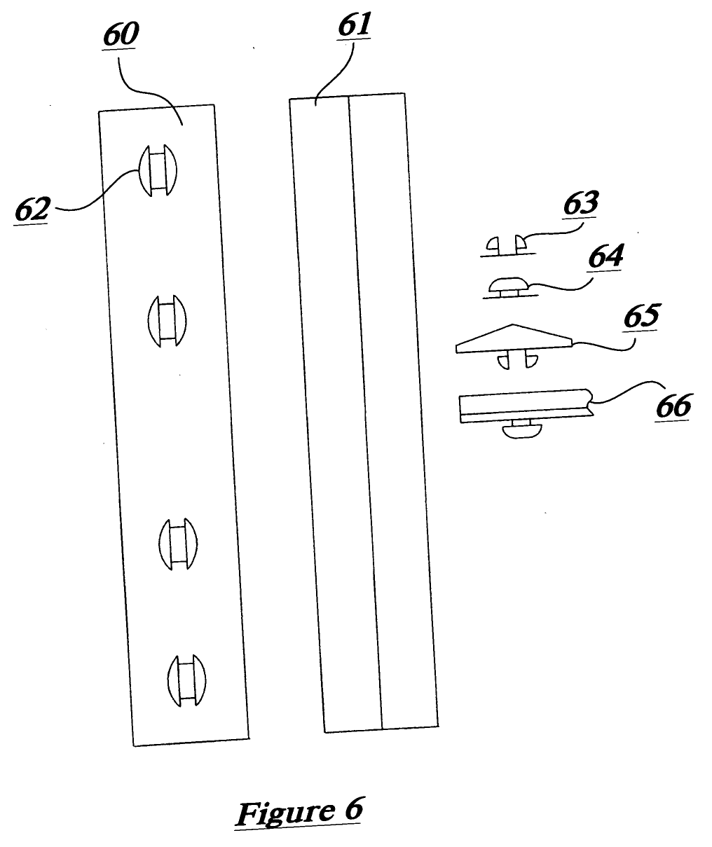

Turning now to FIG. 6, there is shown a detail view of the locking strip used with the two unit floor mounted urinal mat system, indicating the locking tab [62, 63 and 64], the strip bottom [60] and the strip top containing a raised “v” angle to deflect water and urine back into the mat [65].

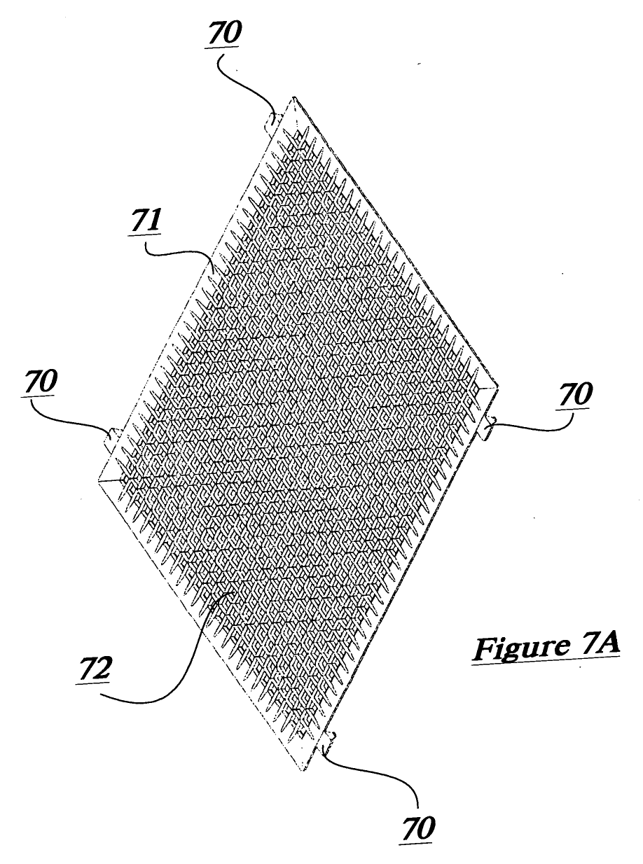

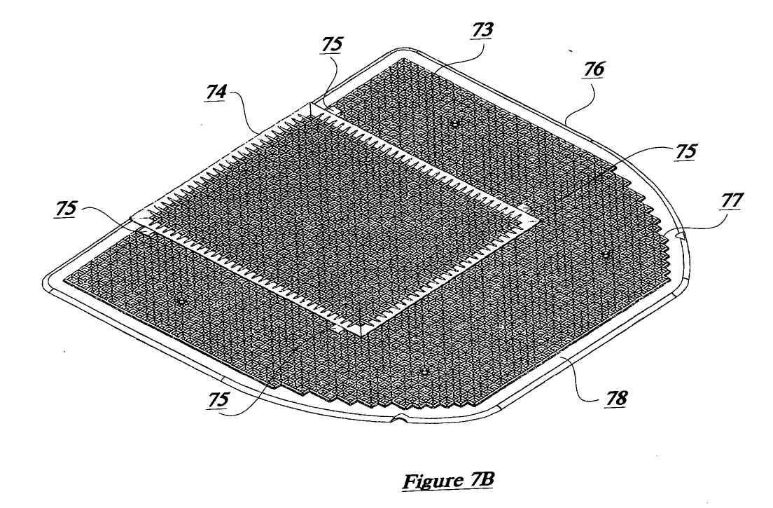

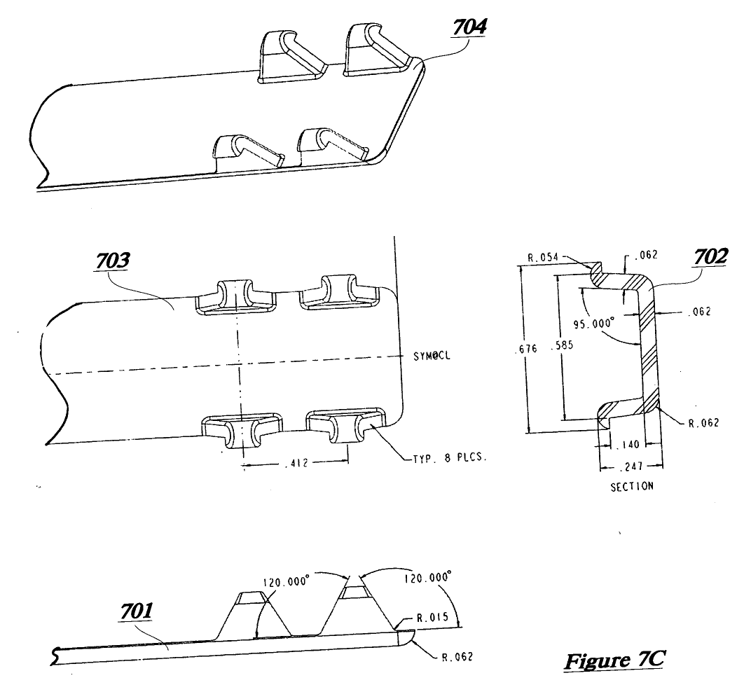

Turning now to FIG. 7A, there is shown an additional embodiment of an extension unit to convert the standard floor mounted commode mat into a mat for use under wall mounted commodes, with the snap lock extensions designed to mat to the specific geometric design of the cartridge top [70], containing a lip that allows the liquid and urine to flow back into the mat surface [71], and utilizing the pyramid shaped geometric design containing a single dagger shaped single slip resistant ridge [72].

Turning now to FIG. 7B, there is shown a standard wall mounted commode mat into which is incorporated the extension unit [74], showing the snap lock units engaged into the mat surface [75].

Turning now to FIG. 7C, there is shown the detail of the snap lock utilized in the extension unit when the commode cartridge top contains the pyramid shaped geometric design with a single dagger slip resistant edge, and the square shaped geometric design to channel the liquid into the absorbing core; with the close up view of the clips in isometric view [704], a top down view [703], a side view [701] and a cutaway view [702].

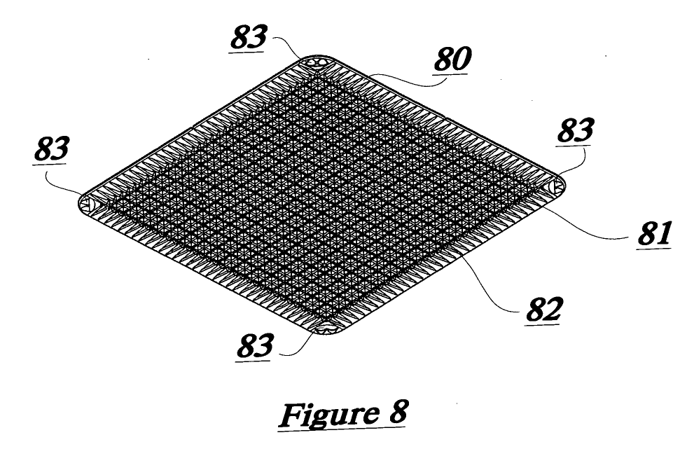

Turning now to FIG. 8, there is shown an additional embodiment of a mat containing the slip resistant pyramid design [81], and incorporating a dagger shaped ridge with a single slip resistant ridge on the lip [82], and providing finger lift tabs [83].

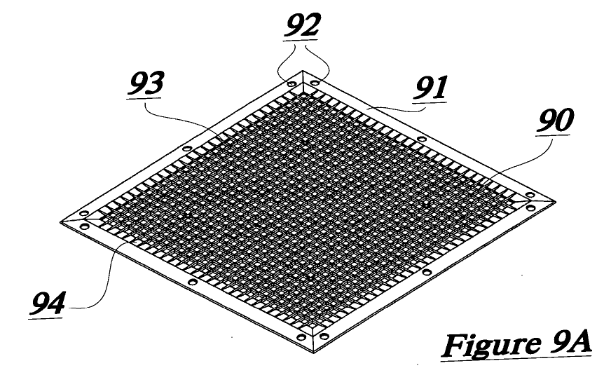

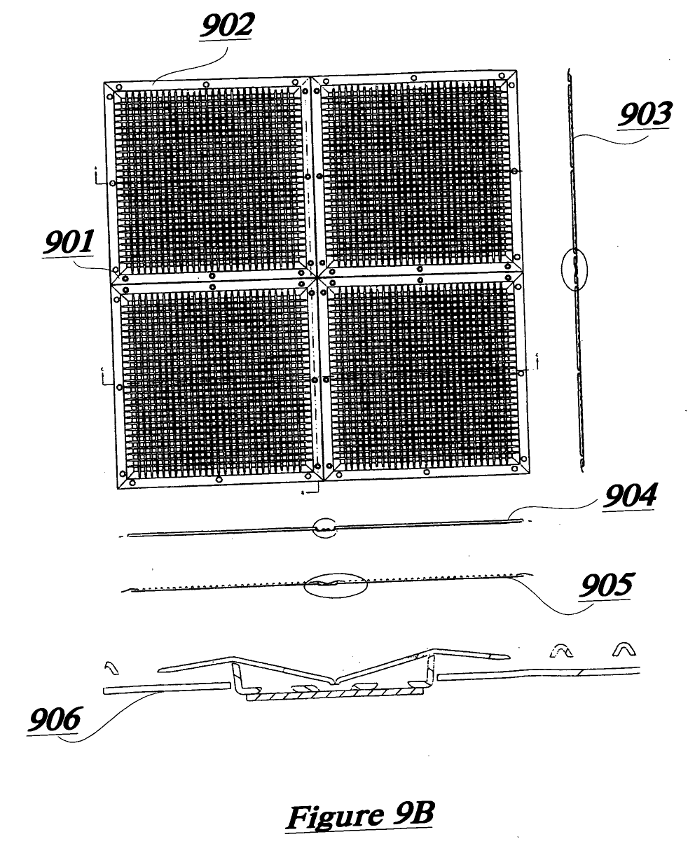

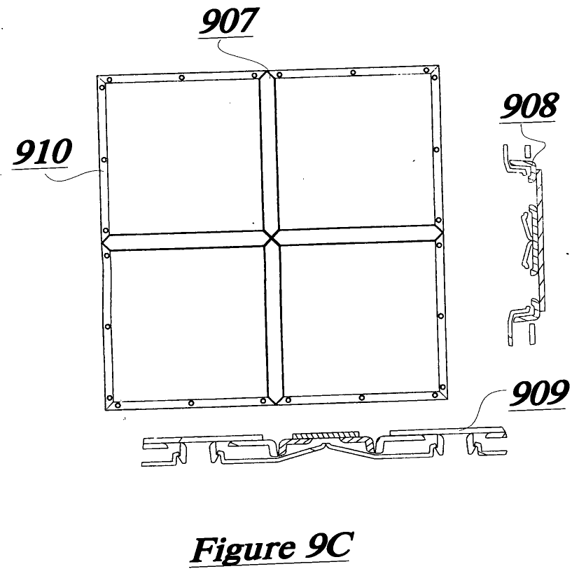

Turning now to FIG. 9A, there is shown an additional embodiment of the stand on mat in a industrial or entrance utility use, consisting of the pyramid shaped geometric design [90 and 93], with the lip draining any liquid back into the absorbing mat [91 and 94], and containing holes in the lip for attaching a locking strip allowing additional mats to be combined into a larger surface protection system [92].

Turning now to FIG. 9B, there is shown the reverse side of four industrial or entrance utility mats locked together with locking strips [901 and 902], consisting of snap lock clips contained on the locking strip [905], with a close up view [906], a side view [904] and a vertical view [903].

Turning now to FIG. 9C, there is shown the reverse side of the four industrial or entrance utility mats locked together [907 and 910], with close up views of the locking units when mated together [908 and 909].

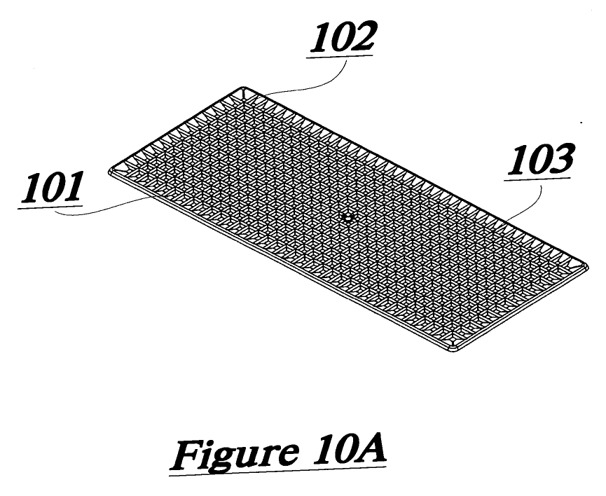

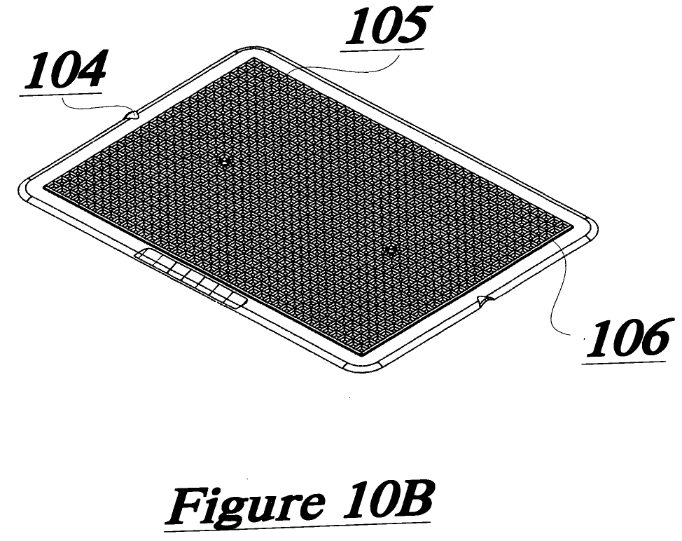

Turning now to FIG. 10A, there is shown another embodiment of the stand on mat idea, consisting of a smaller mat containing the pyramid shaped geometric design [101] and dagger shaped slip resistant edge [102], with an angled lip allowing the liquid to drain back into the absorbent core [103]; for use near coffee pots and microwave ovens, and in front of beverage dispensing machines or floor mounted drinking water fountains;

Turning now to FIG. 10B, there is shown another embodiment of the stand on mat idea, consisting of a medium size mat containing the pyramid shaped geometric design [105], with the dagger single slip resistant edge [106], and with a single lift point on each side [104]; for use under wall mounted drinking fountains, and other areas where a larger size mat is desired.

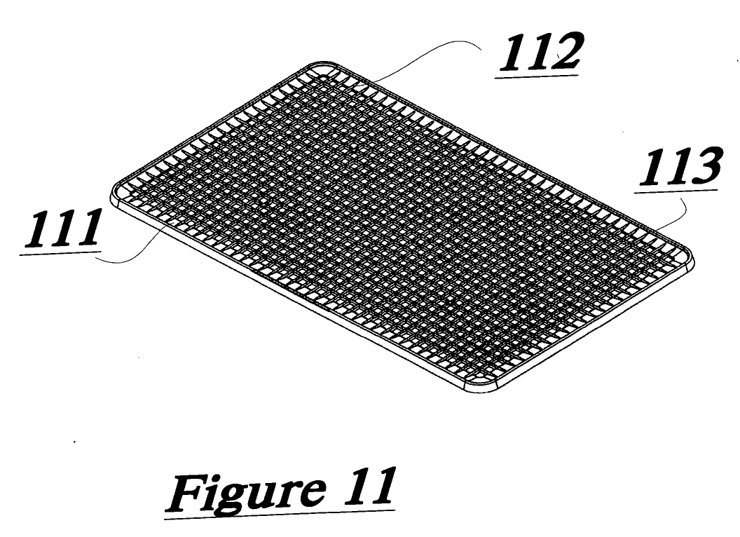

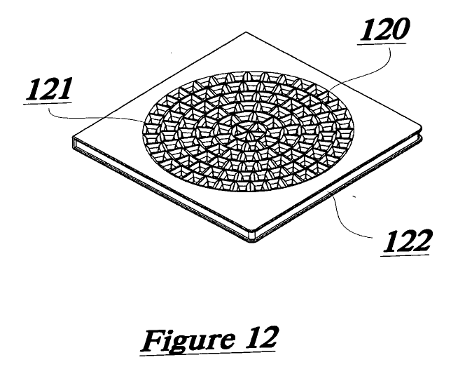

Turning now to FIG. 11, there is shown another embodiment consisting of larger stand on mat, containing the pyramid shaped geometric design [113], with the dagger single slip resistant edge [112], and containing an angled lip allowing any liquid to drain back into the absorbing core; for use as a boot mat in offices or households.

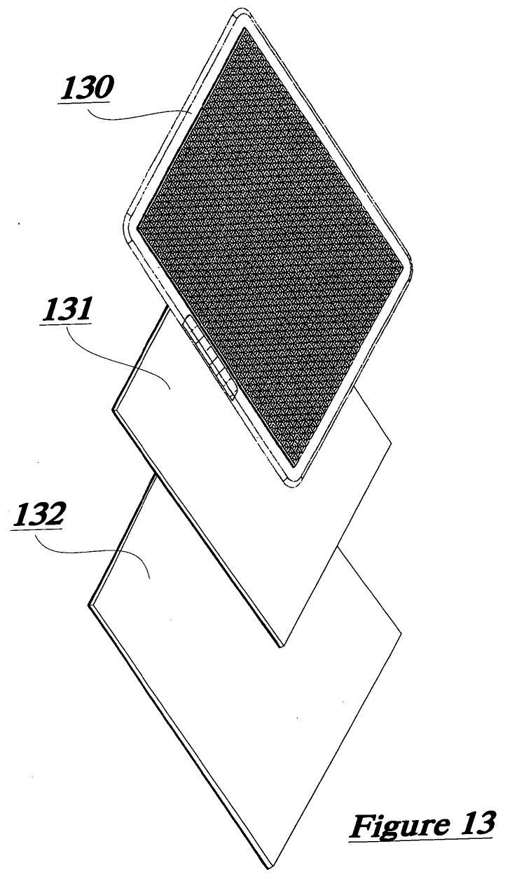

Turning now to FIG. 13, there is shown another embodiment consisting of a table top coaster for hot or cold beverages; consisting of a circular geometric design [121] incorporating the dagger single slip resistant edge [120], and providing a method to open the coaster and change the absorbing core when necessary [122].

Turning now to FIG. 13, there is shown the construction of the stand on mat idea consisting of a cartridge top containing a geometric slip resistant design, manufactured in the preferred embodiment from polypropylene [130], an absorbing core manufactured from non woven material containing a percentage of Super Absorbing Fiber, a percentage of bonding fiber, and a percentage of wood fluff pulp, totaling a minimum of 325 grams per square meter to as much as 1,200 grams per square meter or more, as necessary to accommodate the purpose of the mat [131], which is attached in the assembly process to the top unit by gluing in the preferred embodiment, and finally, the moisture barrier [132], shown in the preferred embodiment consisting of 3/32″ thick black foam rubber that has been flame sealed on both sides and attached by glue to the top unit and the absorbing core, resulting in a single, one piece disposable mat.

Turing to FIG. 14, there is shown in another embodiment the construction of the stand on mat when the cartridge top of any geometric slip resistant design is from paperboard [140], with the absorbing core manufactured from non woven material containing a percentage of Super Absorbing Fiber, a percentage of bonding fiber, and a percentage of wood fluff pulp, totaling a minimum of 325 grams per square meter to as much as 1,200 grams per square meter or more, as necessary to accommodate the purpose of the mat [141], which is attached in the assembly process to the top unit by gluing in the preferred embodiment, and the moisture barrier [142], shown in the optional embodiment consisting of 1/16″ thick clear film, and a slip resistant bottom unit manufactured from paperboard, containing a natural slip resistant surface, said components attached by glue to each other, resulting in a single, one piece disposable mat.

In the preferred embodiment, these features allow the users of urinals and commodes, by standing on the mat, to stand closer than other inventions. Additionally, the size of the mat can be increased since it is not necessary for the user to straddle the mat as in other inventions. Additionally, the ability to stand on the mat allows the use of larger configurations in the design of the mat, providing greater floor surface protection. Additionally, the potential for dislodging the mat is decreased as it is stepped upon as opposed to stepped around as in other inventions.

While the invention has been described in connection with both preferred and additional embodiments, it is not intended to limit the scope of the invention to the particular form set forth, but on the contrary, it is intended to cover such alternatives, modifications, and equivalents as may be included within the spirit and scope of the invention as defined by the appended claims.

We claim:

1. An article of manufacture for protecting floor surfaces from accidental liquid spills, and in the context of restrooms, including urine and water, consisting of a mat comprising of:
a cartridge unit including:
(a) a moisture absorbing means for absorbing and retaining liquid,
(b) a cartridge top component disposed over and connected to said moisture absorbing means for collecting and draining liquid into said moisture absorbing means,
(c) a barrier means disposed beneath and connected to said moisture absorbing means for preventing moisture escape from said moisture absorbing means,
wherein the improvement comprises:
(i) a top unit with a slip resistant surface using ribbing or other effective methods to provide the slip resistant surface;
(ii) a barrier disposed beneath and connected to the moisture absorbing means having a low coefficient of friction to resist accidental movement during use;
(ii) which apparatus, when assembled using two or more components, comprise a one piece apparatus after manufacture.

2. A surface protection system unit of claim 1 that a provides for the user to stand on the apparatus, allowing the user to be close to the urinal, toilet, beverage vending machine, drinking fountain, or other embodiments of the invention;

3. A surface protection system of claim 1 that incorporates a slip resistant top grid of any geometric design;

4. A surface protection system unit of claim 1 with a high geometric gird design providing a greater distance between the absorbent core and the user;

5. A surface protection system unit of claim 1 wherein the absorbent core is made of multiple layers of non woven super absorbent fibers or polymers.

6. A surface protection system unit of claim 1 wherein the top unit is manufactured of durable and biodegradable material, including biopolymers such as cassava starch and cellulose, polyactides, polyhydroxyalkanoates, aliphatic polyesters, polymers of alginates, paperboard and other durable or biodegradable materials.

7. A surface protection system unit of claim 1 wherein a bottom component is added to the moisture barrier manufactured of durable and biodegradable material, including biopolymers such as cassava starch and cellulose, polyactides, polyhydroxyalkanoates, aliphatic polyesters, polymers of alginates, paperboard and other durable or biodegradable materials.

8. A surface protection system of claim 6 that is one apparatus after manufacture.

9. An article of manufacture for protecting the counter and table top surfaces from accidental liquid spills, including coffee, carbonated beverages and water, comprising:
a cartridge unit including:
(a) a moisture absorbing means for absorbing and retaining liquid,
(b) a cartridge unit component into which the moisture absorbing means is contained for collecting and draining liquid into said moisture absorbing means,
(c) a barrier means disposed beneath and connected to said moisture absorbing means for preventing moisture escape from said moisture absorbing means,
c) All components being combined into one unit

10. A surface protection system of claim 9 where said cartridge unit component is manufactured to snap open and allow the moisture absorbing means to be changed.
